(19) United States
(12) Patent Application Publication
(10) Pub. No.: US 2003/0234812 A1
(43) Pub. Date: Dec. 25, 2003

(54) Visual decision maker

(76) Inventors: Steven M. Drucker, Bellevue, WA (US); Timothy Regan, Sammamish, WA (US); Markus Lofstrom, Seattle, WA (US); Asta L. Glatzer, Redmond, WA (US); Curtis Wong, Bellevue, WA (US)

Correspondence Address: AMIN & TUROCY, LLP, 24TH FLOOR, NATIONAL CITY CENTER, 1900 EAST NINTH STREET, CLEVELAND, OH, 44114, US

(21) Appl. No.: 10/178,121

(22) Filed: Jun. 24, 2002

(51) Int. Cl. G09G 5/00

(52) U.S. Cl. 345/751

(57) ABSTRACT

The present invention provides a system and method for collaborative decision-making. The system includes a user model component and a user feedback component. The user feedback component presents information associated with media content to users and receives feedback related to the information from the users. The user model component models the feedback received from the users and modifies the information associated with media content based, at least in part, upon the model. The user model component can, for example, utilize metadata associated with media content in order to model user behavior and/generate recommendations. The user model component can employ artificial intelligence technique(s) such as Bayesian reasoning to model user behavior and/or generate recommendations.

### TECHNICAL FIELD

The present invention relates generally to collaborative decision-making and more particularly to a system and method facilitating collaborative decision-making.

### BACKGROUND OF THE INVENTION

Group decision(s) can be difficult to reach. Each member of the group has his/her own likes and dislikes which, even in a limited group, can prove unmanageable in reaching a group decision. Further, topic(s) of common interest or disinterest can spark interesting conversation even among strangers.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention provides a system and method for collaborative decision-making. In accordance with an aspect of the present invention, a collaborative decision-making system having a user model component and a user feedback component is provided. Optionally, the system can include a media information store.

The system facilitates collaborative decision-making based, at least in part, upon user preferences for media content (e.g. movies, restaurants, art selections, interior design selections, travel destinations, music selections and/or items to purchase). The system employs a knowledge acquisition system for modeling multiple users' preferences in order to facilitate conversation and/or decision-making activities. In one implementation a stream of images, continuously adjusted based on multiple users' responses is presented to several users and a model of preferences for the users is built based on their like/dislike responses. Given this model, a list of recommendations is dynamically generated.

For example, the system can display images from movies and employ collaborative filtering to make recommendations to the users. Thus, user preferences for multimedia content such as movies can be inferred from a series of preferences for various types of content with variations in selected parameters such as genre or actor.

The user feedback component presents information associated with media content to users and receives feedback related to the information from the users. The feedback can include, for example, an affirmative response, a skip response and/or a negative response.

The user model component models the feedback received from the users and modifies the information associated with media content based, at least in part, upon the model. For example, the user model component can present a stream of media content (e.g., images), adjusted based on multiple users' responses. Using these responses, the user model component constructs a model of preferences for the users. Thus, the user model component can update the model based, at least in part, upon users' responses and then present media content based on the updated model. The system can adapt to the combination of users' unique tastes and interests.

Given this model, the user model component can generate a list of recommendations. By doing this simultaneously with multiple users, in a dynamic fashion, the system can, for example, instigate conversation among the users. For example, the user model can intersperse media content the user model predicts one user will like and another user will dislike to foster conversation. Further, media content (e.g., images) can also be interspersed based, at least in part, on Value of Information Theory (e.g., to fill in gaps in the user model component). Additionally and/or alternatively, the system can facilitate a collaborative decision of the users.

The user model component can, for example, utilize metadata associated with media content (e.g., actor(s), actress(es), producer(s), director(s) and/or genre(s)) in order to model user behavior and/generate recommendations. The user model component can employ artificial intelligence technique(s) (e.g., Bayesian reasoning, Bayesian classifiers and other statistical classifiers, including decision tree learning methods, support vector machines, linear and non-linear regression and/or neural networks) to model user behavior and/or generate recommendations.

The optional media information store can store at least some of the information associated with media content. For example, the media information store can store images associated with media content (e.g., covers of movie videocassettes and/or movie DVD's) and/or metadata associated with the media content.

One aspect of the present invention provides for a stand-alone collaborative decision-making system. Another aspect of the present invention provides for a distributed decision-making system. The distributed decision-making system includes a user model component and user feedback components. The user feedback components include an output device, for example, a computer monitor, a television screen, a touch screen, a personal digital assistant and/or a mobile telephone display. The user feedback component further includes an input device, for example, a joystick, a keyboard, a remote control, a pointing device and/or a mouse. The user feedback components are coupled to the user model component via, for example, a parallel electrical connection, a serial electrical connection, a cable television connection, a computer network connection (e.g., the Internet), a Digital Subscriber Line (“DSL”), a telephone line, a cable modem, a wireless data communications link and/or an integrated services digital network (“ISDN”).

In one implementation, users “converse” with one another via instant messaging and/or telephony. The system can present a stream of images associated with art to which users each provide an affirmative, skip or negative response. The system can model the users' responses and provide further images associated with art to stimulate conversation (e.g., via instant messaging and/or telephony), between the users (e.g., art which the system predicts both users will agree upon and/or art which the system predicts the users will not agree up). Thus, the system can facilitate conversation amongst physically remote users.

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a block diagram of a collaborative decision-making system in accordance with an aspect of the present invention.

FIG. 2 is a block diagram of a stand-alone collaborative decision-making system in accordance with an aspect of the present invention.

FIG. 3 is a block diagram of a distributed collaborative decision-making system in accordance with an aspect of the present invention.

FIG. 4 is a block diagram of an input device in accordance with an aspect of the present invention.

FIG. 5 is an exemplary user interface in accordance with an aspect of the present invention.

FIG. 6 is a flow chart illustrating a method for collaborative decision-making in accordance with an aspect of the present invention.

FIG. 7 illustrates an example operating environment in which the present invention may function.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the term “computer component” is intended to refer to a computer-related entity, either hardware, a combination of hardware and software, software, or software in execution. For example, a computer component may be, but is not limited to being, a process running on a processor, a processor, an object, an executable, a thread of execution, a program, and/or a computer. By way of illustration, both an application running on a server and the server can be a computer component. One or more computer components may reside within a process and/or thread of execution and a component may be localized on one computer and/or distributed between two or more computers.

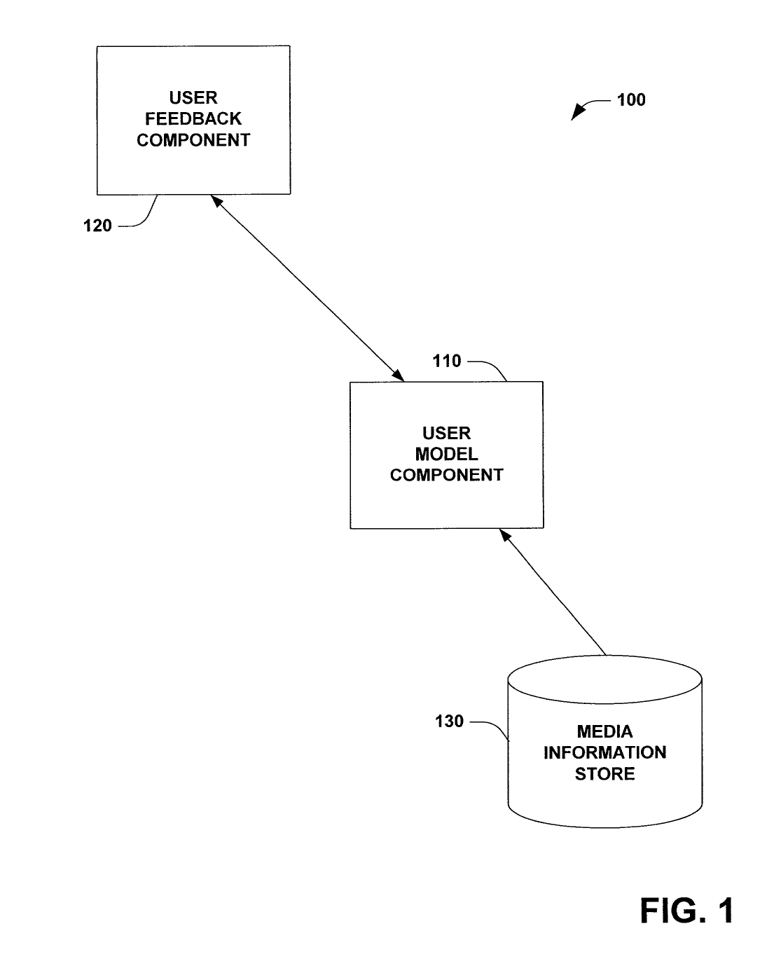

Referring to FIG. 1, a collaborative decision making system 100 in accordance with an aspect of the present invention is illustrated. The system 100 includes a user model component 110 and a user feedback component 120. Optionally, the system 100 can include a media information store 130. The system 100 facilitates collaborative decision-making based, at least in part, upon user preferences for media content (e.g., movies, restaurants, art selections, interior design selections, travel destinations, music selections and/or items to purchase). The system 100 employs a knowledge acquisition system for modeling multiple users' preferences in order to facilitate conversation and/or decision-making activities. In one implementation a stream of images, continuously adjusted based on multiple users' responses is presented to several users and a model of preferences for the users is built based on their like/dislike responses. Given this model, a list of recommendations is dynamically generated.

For example, the system 100 can display images from movies and employ collaborative filtering to make recommendations to the users. Thus, user preferences for multimedia content such as movies can be inferred from a series of preferences for various types of content with variations in selected parameters such as genre or actor.

The user feedback component 120 presents information associated with media content to at users. For example, the information can be presented via a computer monitor, television screen, touch screen, personal digital assistant and/or mobile telephone display. The user feedback component 120 further receives feedback related to the information from the users. The feedback can include, for example, an affirmative response (e.g., yes, up arrow and/or thumbs up), a skip response and/or a negative response (e.g., no, down arrow and/or thumbs down). For example, the feedback can be received via a joystick, a keyboard, a remote control, a pointing device and/or a mouse. Additionally and/or alternatively, the feedback can represent a scaled response (e.g., 0-100), for example, based on a numeric input and/or sliding scale input device.

The user model component 110 models the feedback received from the users and modifies the information associated with media content based, at least in part, upon the model. For example, the user model component 110 can present a stream of media content (e.g., images), adjusted based on multiple users' responses. Using these responses, the user model component 110 constructs a model of preferences for the users. Thus, the user model component 100 can update the model based, at least in part, upon users' responses and then present media content based on the updated model. The system 100 can adapt to the combination of users' unique tastes and interests.

Given this model, the user model component 110 can generate a list of recommendations. By doing this simultaneously with multiple users, in a dynamic fashion, the system 100 can, for example, instigate conversation among the users. For example, the user model can intersperse media content the user model 110 predicts one user will like and another user will dislike to foster conversation. Further, media content (e.g., images) can also be interspersed based, at least in part, on Value of Information Theory (e.g., to fill in gaps in the user model component 110). Additionally and/or alternatively, the system 100 can facilitate a collaborative decision of the users.

The user model component 110 can, for example, utilize metadata associated with media content (e.g., actor(s), actress(es), producer(s), director(s) and/or genre(s)) in order to model user behavior and/generate recommendations. The user model component 110 can employ artificial intelligence technique(s) (e.g., Bayesian reasoning, Bayesian classifiers and other statistical classifiers, including decision tree learning methods, support vector machines, linear and non-linear regression and/or neural networks) to model user behavior and/or generate recommendations.

For example, a system 100 can be employed in a stand-alone environment such as a coffee house. The user feedback component 120 can include a computer monitor to present information and two computer mice to receive user feedback. The system 100 can present a stream of images associated with movies to which the users each provide an affirmative, skip or negative response. The system 100 can model the users' responses and provide further images associated with movies to stimulate conversation between the users (e.g., movies which the system 100 predicts both users will agree upon and/or movies which the system 100 predicts the users will not agree up).

The optional media information store 130 can store at least some of the information associated with media content. For example, the media information store 130 can store images associated with media content (e.g., covers of movie videocassettes and/or movie DVD's) and/or metadata associated with the media content.

While FIG. 1 is a block diagram illustrating components for the system 100, it is to be appreciated that the collaborative decision making system 100, the user model component and/or the user feedback component 120 can be implemented as one or more computer components, as that term is defined herein. Thus, it is to be appreciated that computer executable components operable to implement the collaborative decision making system 100, the user model component 110 and/or the user feedback component 120 can be stored on computer readable media including, but not limited to, an ASIC (application specific integrated circuit), CD (compact disc), DVD (digital video disk), ROM (read only memory), floppy disk, hard disk, EEPROM (electrically erasable programmable read only memory) and memory stick in accordance with the present invention.

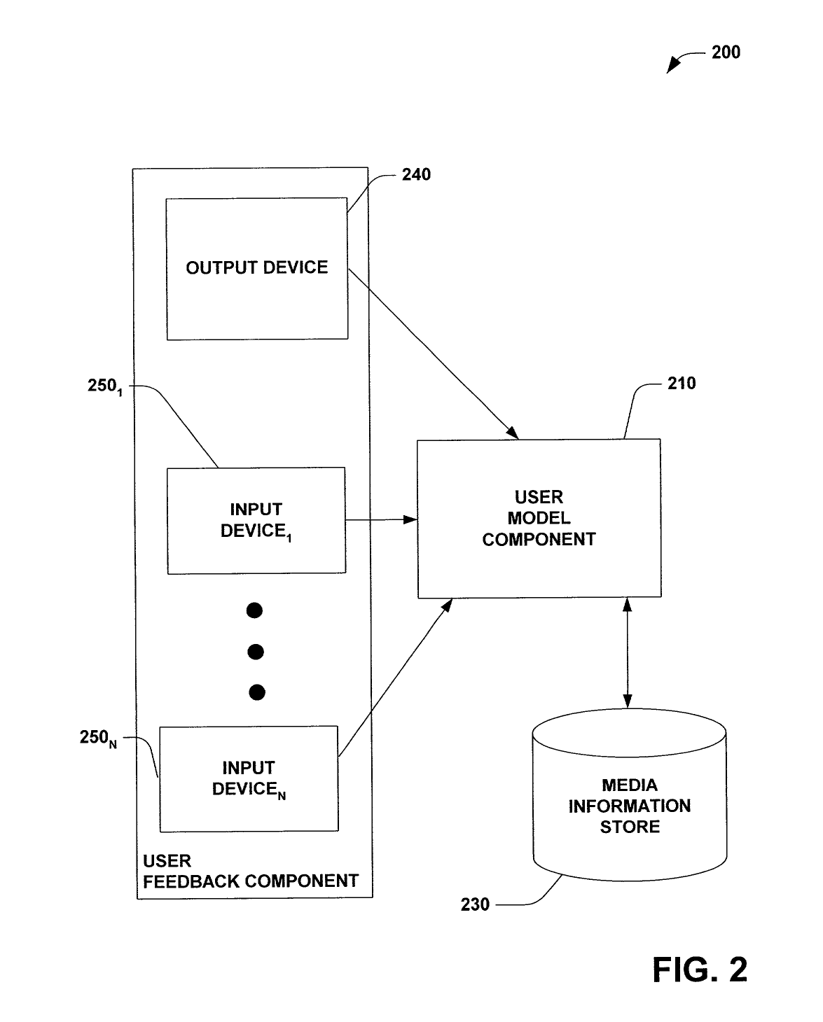

Turning to FIG. 2, a stand-alone collaborative decision-making system 200 in accordance with an aspect of the present invention. The system 200 includes a user model component 210 and a user feedback component 220. Optionally, the system 200 can include a media information store 230. The user model component 210 models feedback received from users and modifies the information associated with media content based, at least in part, upon the model, as discussed supra. The user feedback component 220 includes an output device 240 which can be, for example, a computer monitor, a television screen, a touch screen, a personal digital assistant and/or a mobile telephone display. The user feedback component 220 further includes a first input device 250₁ through an Nth input device 250_{N}, N being an integer greater than or equal to two. The first input device 250₁ through the Nth input device 250_{N} can be referred to collectively as the input devices 250. For example, the input devices 250 can be, for example, a joystick, a keyboard, a remote control, a pointing device, a PDA and/or a mouse. Typically, the output device 240 and the input devices 250 are located in proximity to one another (e.g., in the same room).

The system 200 can be employed, for example, in movie rental environment in order to facilitate selection of a movie rental by two users. The stand-alone system 200 can present a stream of images associated with movies to which the users each provide an affirmative, skip or negative response. The system 200 can model the users' responses and provide further images associated with movies to facilitate selection of a movie rental by the users. The system 200 can take into account, for example, movies available for rental along with user responses.

It is to be appreciated that the user model component 210 and/or the user feedback component 220 can be computer component(s) as that term is defined herein.

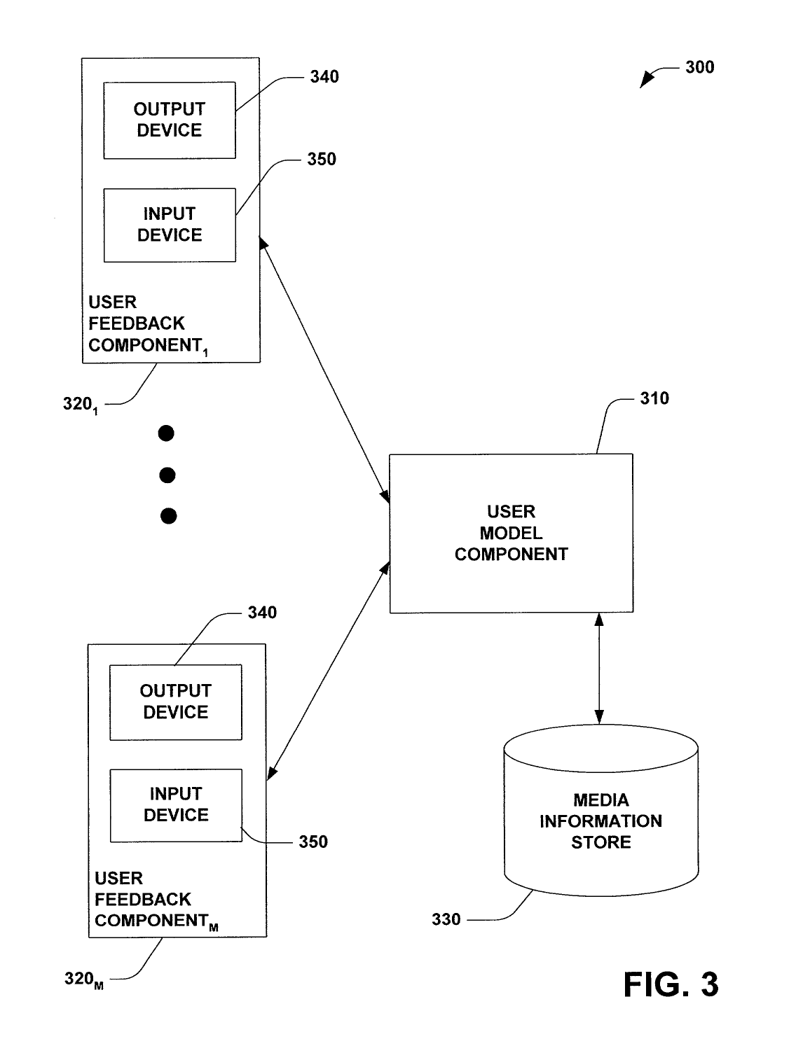

Next, referring to FIG. 3, a distributed collaborative decision-making system 300 in accordance with an aspect of the present invention is illustrated. The system 300 includes a user model component 310 and a first user feedback component 320₁ through an Mth user feedback component 320_{M}, M being an integer greater than or equal to two. The first user feedback component 320₁ through the Mth user feedback component 320_{M} can be referred to collectively as the user feedback components 320. Optionally, the system 300 can include a media information store 330.

The user model component 310 models feedback received from users and modifies the information associated with media content based, at least in part, upon the model, as discussed supra. The user feedback components 320 include an output device 340 which can be, for example, a computer monitor, a television screen, a touch screen, a personal digital assistant and/or a mobile telephone display. The user feedback component 320 further includes an input device 350, for example, a joystick, a keyboard, a remote control, a pointing device and/or a mouse. The user feedback components 320 are coupled to the user model component 310 via, for example, a parallel electrical connection, a serial electrical connection, a cable television connection, a computer network connection (e.g., the Internet), a Digital Subscriber Line (“DSL”), a telephone line, a cable modem, a wireless data communications link and/or an integrated services digital network (“ISDN”).

In one implementation, users “converse” with one another via instant messaging and/or telephony. The system 300 can present a stream of images associated with art to which users each provide an affirmative, skip or negative response. The system 300 can model the users' responses and provide further images associated with art to stimulate conversation (e.g., via instant messaging and/or telephony), between the users (e.g., art which the system 300 predicts both users will agree upon and/or art which the system 300 predicts the users will not agree up). Thus, the system 300 can facilitate conversation amongst physically remote users.

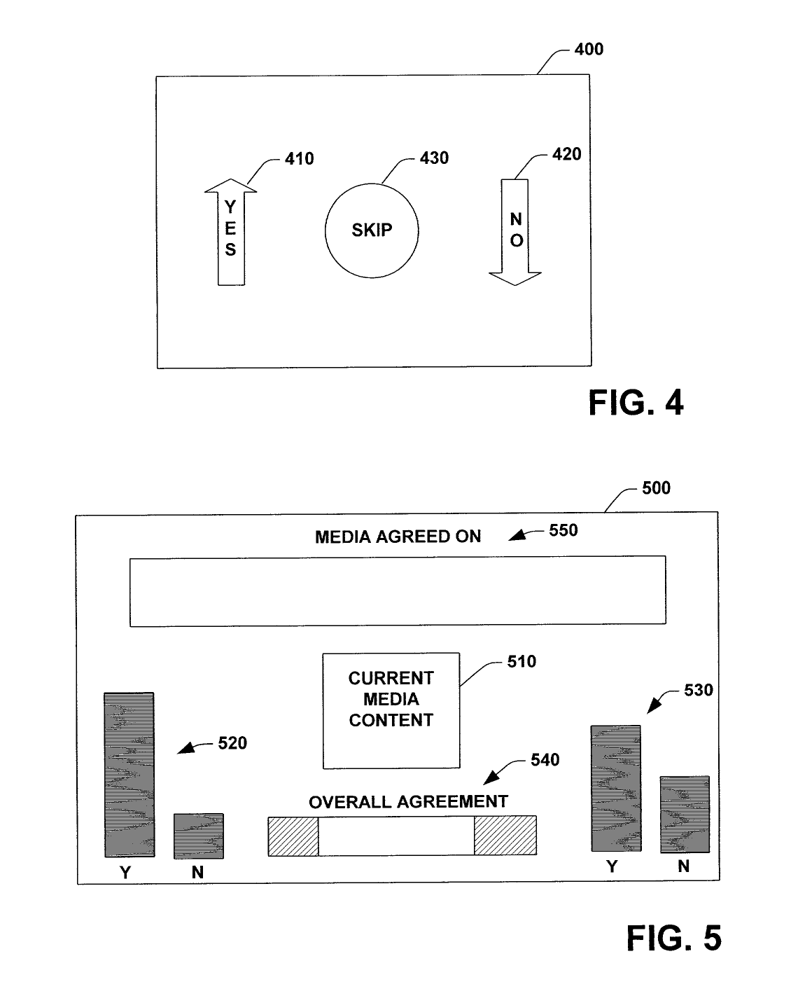

Referring to FIG. 4, an input device 400 in accordance with an aspect of the present invention is illustrated. The input device 400 includes a yes key 410, a no key 420 and a skip key 430. For example, the yes key 410 can be used for an affirmative response, the no key 420 can be used for a negative response and the skip key 430 can be used to indicate a skip response.

The input device 400 is presented for purposed of illustration of an aspect of the present invention and is not intended to limit the present invention. For example, in accordance with another aspect of the present invention, an input device employing a single key having multiple functions can be employed. Accordingly, any suitable means for providing user responses can be utilized in accordance with the present invention.

Turning to FIG. 5, an exemplary user interface 500 in accordance with an aspect of the present invention is illustrated. The user interface 500 includes a current media content 510, a first user response display 520, a second user response display 530, an overall agreement display 540 and a media agreed on display 550.

The current media content 510 displays the current media content (e.g., image) to which the users are to respond. The first user response display 520 displays the first user's overall response(s) (e.g., “Y” indicating affirmative response(s) and “N” indicating negative response(s)). The second user response display 520 likewise displays the second user's overall response(s). The overall agreement display 540 graphically displays an aggregate of the users' responses. The media agreed on display 550 displays media content (e.g., image(s)) upon which the users agreed (e.g., to foster conversation and/or collaborative decision-making).

For example, movie(s) which are approved by substantially all users can move to media agreed on display 550 while those disliked by substantially all users can drop down to the bottom of the display. Further, movie(s) that elicit disagreement can remain longer on the display (e.g., to allow for discussion).

While FIG. 5 illustrates an exemplary user interface for two users, it is to be appreciated the present invention is not limited to two users. Thus, in accordance with an aspect of the present invention, any suitable number of users can be utilize the system and/or method of the present invention.

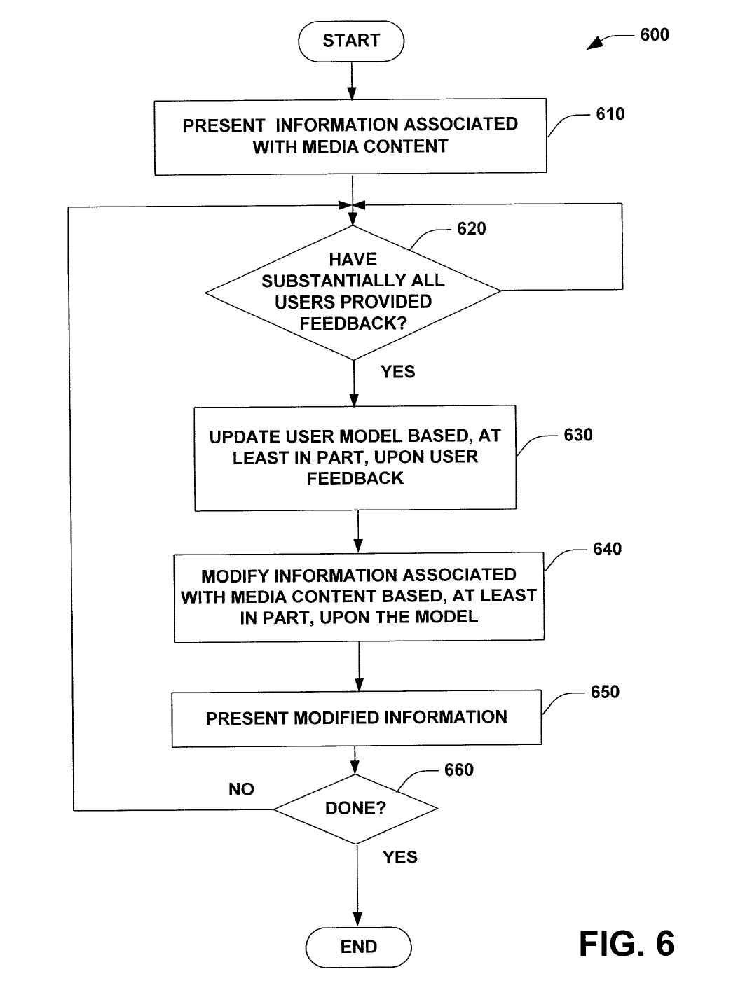

In view of the exemplary systems shown and described above, a methodology that may be implemented in accordance with the present invention will be better appreciated with reference to the flow chart of FIG. 6. While, for purposes of simplicity of explanation, the methodology is shown and described as a series of blocks, it is to be understood and appreciated that the present invention is not limited by the order of the blocks, as some blocks may, in accordance with the present invention, occur in different orders and/or concurrently with other blocks from that shown and described herein. Moreover, not all illustrated blocks may be required to implement the methodology in accordance with the present invention.

The invention may be described in the general context of computer-executable instructions, such as program modules, executed by one or more components. Generally, program modules include routines, programs, objects, data structures, etc. that perform particular tasks or implement particular abstract data types. Typically the functionality of the program modules may be combined or distributed as desired in various embodiments.

Turning to FIG. 6, a method 600 for collaborative decision-making in accordance with an aspect of the present invention is illustrated. At 610, information associated with media content is presented (e.g., via a computer screen). At 620, a determination is made as to whether substantially all users have provided feedback (e.g., “yes”, “no” or skip). If the determination at 620 is NO, processing continues at 620. If the determination at 620 is YES, at 630, a user model is updated based, at least in part, upon the user feedback. At 640, information associated with media content is modified based, at least in part, upon the updated model. At 650 the modified information is presented. At 660, a determination is made as to whether the users are done. If the determination at 660 is NO, processing continues at 620. If the determination at 660 is YES, no further processing occurs.

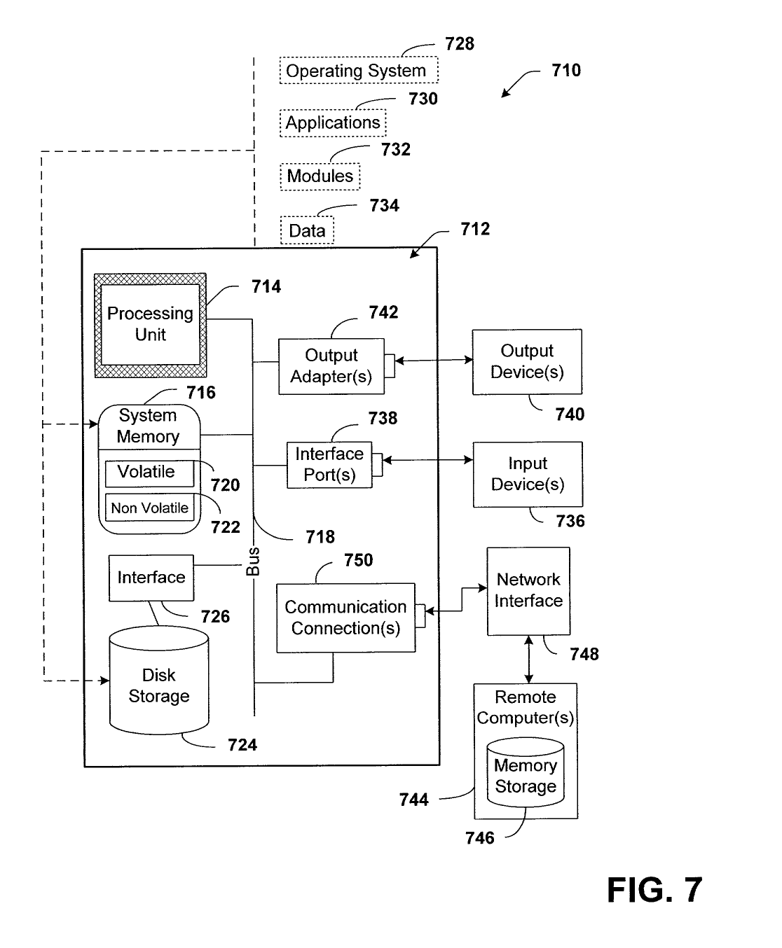

In order to provide additional context for various aspects of the present invention, FIG. 7 and the following discussion are intended to provide a brief, general description of a suitable operating environment 710 in which various aspects of the present invention may be implemented. While the invention is described in the general context of computer-executable instructions, such as program modules, executed by one or more computers or other devices, those skilled in the art will recognize that the invention can also be implemented in combination with other program modules and/or as a combination of hardware and software. Generally, however, program modules include routines, programs, objects, components, data structures, etc. that perform particular tasks or implement particular data types. The operating environment 710 is only one example of a suitable operating environment and is not intended to suggest any limitation as to the scope of use or functionality of the invention. Other well known computer systems, environments, and/or configurations that may be suitable for use with the invention include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 7, an exemplary environment 710 for implementing various aspects of the invention includes a computer 712. The computer 712 includes a processing unit 714, a system memory 716, and a system bus 718. The system bus 718 couples system components including, but not limited to, the system memory 716 to the processing unit 714. The processing unit 714 can be any of various available processors. Dual microprocessors and other multiprocessor architectures also can be employed as the processing unit 714.

The system bus 718 can be any of several types of bus structure(s) including the memory bus or memory controller, a peripheral bus or external bus, and/or a local bus using any variety of available bus architectures including, but not limited to, 7-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 716 includes volatile memory 720 and nonvolatile memory 722. The basic input/output system (BIOS), containing the basic routines to transfer information between elements within the computer 712, such as during start-up, is stored in nonvolatile memory 722. By way of illustration, and not limitation, nonvolatile memory 722 can include read only memory (ROM), programmable ROM (PROM), electrically programmable ROM (EPROM), electrically erasable ROM (EEPROM), or flash memory. Volatile memory 720 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 712 also includes removable/nonremovable, volatile/nonvolatile computer storage media. FIG. 7 illustrates, for example a disk storage 724. Disk storage 724 includes, but is not limited to, devices like a magnetic disk drive, floppy disk drive, tape drive, Jaz drive, Zip drive, LS-100 drive, flash memory card, or memory stick. In addition, disk storage 724 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 724 to the system bus 718, a removable or non-removable interface is typically used such as interface 726.

It is to be appreciated that FIG. 7 describes software that acts as an intermediary between users and the basic computer resources described in suitable operating environment 710. Such software includes an operating system 728. Operating system 728, which can be stored on disk storage 724, acts to control and allocate resources of the computer system 712. System applications 730 take advantage of the management of resources by operating system 728 through program modules 732 and program data 734 stored either in system memory 716 or on disk storage 724. It is to be appreciated that the present invention can be implemented with various operating systems or combinations of operating systems.

A user enters commands or information into the computer 712 through input device(s) 736. Input devices 736 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 714 through the system bus 718 via interface port(s) 738. Interface port(s) 738 include, for example, a serial port, a parallel port, a game port, and a universal serial bus (USB). Output device(s) 740 use some of the same type of ports as input device(s) 736. Thus, for example, a USB port may be used to provide input to computer 712, and to output information from computer 712 to an output device 740. Output adapter 742 is provided to illustrate that there are some output devices 740 like monitors, speakers, and printers among other output devices 740 that require special adapters. The output adapters 742 include, by way of illustration and not limitation, video and sound cards that provide a means of connection between the output device 740 and the system bus 718. It should be noted that other devices and/or systems of devices provide both input and output capabilities such as remote computer(s) 744.

Computer 712 can operate in a networked environment using logical connections to one or more remote computers, such as remote computer(s) 744. The remote computer(s) 744 can be a personal computer, a server, a router, a network PC, a workstation, a microprocessor based appliance, a peer device or other common network node and the like, and typically includes many or all of the elements described relative to computer 712. For purposes of brevity, only a memory storage device 746 is illustrated with remote computer(s) 744. Remote computer(s) 744 is logically connected to computer 712 through a network interface 748 and then physically connected via communication connection 750. Network interface 748 encompasses communication networks such as local-area networks (LAN) and wide-area networks (WAN). LAN technologies include Fiber Distributed Data Interface (FDDI), Copper Distributed Data Interface (CDDI), Ethernet/IEEE 702.3, Token Ring/IEEE 702.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 750 refers to the hardware/software employed to connect the network interface 748 to the bus 718. While communication connection 750 is shown for illustrative clarity inside computer 712, it can also be external to computer 712. The hardware/software necessary for connection to the network interface 748 includes, for exemplary purposes only, internal and external technologies such as, modems including regular telephone grade modems, cable modems and DSL modems, ISDN adapters, and Ethernet cards.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A collaborative decision making system, comprising:
a user feedback component that presents information associated with media content to at least two users and receives feedback related to the information from the users; and,
a user model component that models the feedback and modifies the information associated with media content based, at least in part, upon the model.

2. The system of claim 1, the model employing an artificial intelligence technique.

3. The system of claim 2, the model employing Bayesian reasoning in modeling feedback and modifying the information provided to the user feedback component.

4. The system of claim 1, the user model component modeling the feedback to facilitate conversation between the users.

5. The system of claim 1, the user model component modeling the feedback to facilitate a collaborative decision of the users.

6. The system of claim 5, the collaborative decision being at least one of a movie, a restaurant, a travel destination, a music selection and an item to purchase.

7. The system of claim 1, the user feedback component including a plurality of user input devices.

8. The system of claim 1, the user feedback component including at least one output device.

9. The system of claim 1, further comprising a media information store that stores at least some of the information associated with media content.

10. A collaborative decision-making system, comprising:
a plurality of user feedback components, each user feedback component presenting information associated with media content to a user and receiving feedback related to the information from the user; and,
a user model component coupled to the plurality of user feedback components, the user model further adapted to model the feedback from the plurality of feedback components and modify the information associated with media content based, at least in part, upon the model.

11. The system of claim 10, at least one of the plurality of user feedback components coupled to the user model component via at least one of the Internet and a computer network connection.

12. The system of claim 11, feedback from at least one of the user feedback components being based, at least in part, upon instant messaging.

13. The system of claim 12, feedback from at least one of the user feedback components being based, at least in part, upon telephony.

14. The system of claim 10, at least one of the feedback components including an input device and an output device.

15. The system of claim 14, the input device including at least one of a joystick, a keyboard, a remote control, a pointing device, a personal digital assistant and a mouse.

16. The system of claim 14, the output device including at least one of a computer monitor, a television screen, a touch screen, a personal digital assistant and a mobile telephone display.

17. A method for collaborative decision-making, comprising:
presenting information associated with media content;
updating a user model based, at least in part, upon user feedback; and,
modifying information associated with media content presented based, at least in part, upon the model.

18. A data packet transmitted between two or more computer components that facilitates collaborative decision-making, the data packet comprising:
a data field comprising information associated with media content, the information being based, at least in part, upon a user model that models user feedback.

19. A computer readable medium storing computer executable components of a collaborative decision-making system, comprising:
a user feedback component that presents information associated with media content to at least two users and receives feedback related to the information from the users; and,
a user model component that models the feedback and modifies the information associated with media content based, at least in part, upon the model.

20. A system facilitating detection of unsolicited e-mail, comprising:
means for presenting information associated with media content;
means for receiving user feedback related to the information;
means for modeling the user feedback; and,
means for modifying the information associated with media content based, at least in part, upon the means for modeling.
